(19) United States
(12) Patent Application Publication
(10) Pub. No.: US 2022/0130223 A1
(43) Pub. Date: Apr. 28, 2022

(54) Wireless Presence Check System

(71) Applicants: Marc Garbey, Houston, TX (US); Shannon Furr, Pearland, TX (US)

(72) Inventors: Marc Garbey, Houston, TX (US); Shannon Furr, Pearland, TX (US)

(21) Appl. No.: 17/508,992

(22) Filed: Oct. 23, 2021

Related U.S. Application Data
(60) Provisional application No. 63/104,865, filed on Oct. 23, 2020.

(51) Int. Cl. G08B 21/04; H04W 4/80; G06K 7/10

(52) U.S. Cl. CPC G08B 21/0461; G06K 7/10415; H04W 4/80; G08B 21/0469

(57) ABSTRACT

The present invention relates to a Real-Time Localization Systems (RTLS) utilizing Bluetooth Low Energy (BLE) tags to determine the presence or absence of individual assets, as well as conformations, at designated locations and areas, generally. Further, Bluetooth Low Energy (BLE) tags are utilized to determine if a patient is either present or absent, a seat or bed is either occupied or unoccupied, an ingress or egress is open or closed, or a container or enclosed space is open or closed—all through signal detection and signal obstruction.

### CROSS-REFERENCE TO RELATED APPLICATIONS

U.S. Provisional Patent Application No. 63/104,865 filed on Oct. 23, 2020

### FEDERALLY SPONSORED RESEARCH OR DEVELOPMENT

Non-Applicable

### FIELD OF THE INVENTION

The present invention relates to a Real-Time Localization Systems (RTLS) utilizing Bluetooth Low Energy (BLE) tags to determine the presence or absence of assets, as well as conformations, at designated locations and areas. Specifically, Bluetooth Low Energy (BLE) tags are utilized to determine if a patient is either present or absent, an ingress or egress is open or closed, or a container or enclosed space is open or closed—all through signal detection and signal obstruction.

### BACKGROUND

Essentially, RFID technology can be categorized into two types: the first type is ‘active’ RFID technology (e.g., BLE), in which a radio frequency ID (RFID) tag or label encompasses an integrated power source (i.e. battery) that allows for transmission of signals and data to a radio frequency antenna/reader, and a second type of ‘passive’ RFID technology, in which the RF tag has no integrated or embedded power source and instead relies upon electromagnetic coupling from an antenna/reader wherein the reader transfers power from the reader, though the antenna, to the RFID tag. BLE (or ‘active’ RFID) operates by sending out transmissions (i.e., “beaconing”) to a reader which, in turn, transmits to the cloud. By definition, Bluetooth Low Energy uses little energy and can last on the order of 5 or more years dependent upon output and use. The BLE device, commonly referred to as a “tag”, “tracker” or “tile”, may be mobile or stationary and the reader or “interrogator” itself may be a moveable, as is the case with a hand-held device, or a fixed reader which are designed to “read” specific interrogation zones through the detection and monitoring of electromagnetic signals which may be set to survey a set, predetermined space or area. Contrariwise, mobile readers in “passive RFID”, are characteristically either hand-held or mounted on mobile transports acting to energize BLE trackers in close proximity. Clearly, one advantage of the present invention is that, in stationary tags, a static reader may be utilized to interrogate a specific and defined area with a greatly heightened sensitivity and reliability. This largely stationary-on-stationary approach provides for directed reading not enjoyed by mobile tags and/or mobile readers thereby increasing accuracy and sensitivity without corresponding increases in power requirements.

And while greater emphasis has traditionally been placed on mobile BLE tags, as seen in terms of detection and tracking (See generally key finders' Bluetooth Low Energy beacons used for location of keys, tools, luggage, pets, laptops, wallets and the like), it is stationary applications, through allowance or occlusion of a tag's signals, that lends itself more readily to novel applications of the present invention. Manifestly, as is the case with patient seating and door monitoring, that RFID BLE tags are positioned in a discretely observable and defined area. Even in the mobile application of the present invention, where a transport may be mobile, the observable area is nonetheless confined to a distinct area of the transport (e.g., gurney) which defines the occupied or unoccupied space and state.

Therefore, for the purposes of the present invention, it is ‘active’ RFID technology offering the greatest utility. As opposed to “passive RFID” technology, truly “active RFID” technology (e.g., those technologies using an active reader and an actively electromagnetically generating tag) require a series of integrated components: an integrated circuit (i.e., microchip), a battery, a transmitting antenna and a receiving antenna. This combination constitutes what is more commonly referred to as an ‘inlay’. The RFID tag itself relies upon a transmitter, to transmit a signal, and a reader to read a signal from a tag or group of tags in its ‘read frequency range’. Signals transmitted back to the receiver can be made to monitor information ranging from very simple (e.g., a unique identification number, tag serial numbers, lot numbers and/or production dates), to multi-variant (e.g., including environmental information and relation to space) thereby differentiating even physically identical assets by spatial location, orientation and location in space (via received signal strength, time of arrival and angle of arrival). This allows the reader to determine not only the identity, age, grade and origin (and battery like) of that asset but also its location relative to the interrogator (as well as other assets) in 2D and even 3D space.

Real-Time Localization Systems (RTLS) in the present application are used to not only identify and track assets (e.g., items and people) in real time through the use of “tagging” or “labeling” but also to determine occupancy and, conformation and orientation. Said wireless tags, presently Bluetooth Low Energy (BLE) tags, may be attached or adhered to objects to be monitored and tracked wherein electromagnetic fields are utilized to equally identify and track tagged objects and, more importantly, to agnostically determine the presence or absence of individual patients in defined areas and spaces. The system consists of a radio transponder, a radio receiver and a radio transmitter. Receivers are positioned at various locations to detect wireless signals to “read” each tag's transmitted data using an algorithm based on the (1) absence or presence of a received signal and (2) strength indicator (or transmission time). By utilizing AIDC (automatic identification and data capture), information about an asset can be utilized to identify the conformation of an object (vacant, occupied, open, closed, dormant or ‘in use’), processed to determine the change in conformation of the asset wherein data can be collected and compiled—all without human involvement.

Further, while the prior art is relies almost exclusively upon inherent mobility in currently employed RFID devices, the present invention does not seek to enhance the signal or extend its detectability or readability, but rather to allow for signal occlusion/dampening and to only monitor the presence or absence of asset conformation (and change in conformation) at specific locations as in occupancy, vacancy and the opening or closing of doors (or drawers) through the presence or absence of electromagnetic signals (e.g., the presence of a signal equates to the absence of patient and vice versa). The discrete use of BLE technology being aided in its utility where the power requirements are low, the size and cost is small and the threshold for adaptation is equally diminutive. Too, said low power may be leveraged or spared wherein RFID tags, either passive active or a combination of the two, may communicate directly with the receiver, indirectly with the receiver, may communicate with one another, recommunicate a signal from tag to tag, or any blend or reciprocal accommodation thereof.

Succinctly, inventors are advancing a solution and system that is autonomous, robust and easy to implement (i.e., with as little install as possible), which is wireless, and highly amendable to retrofitting. A typical example is a system that counts the number of people sitting in a waiting area, or a solution to determine which beds are occupied in the pre-operative area of a hospital. In particular, inventors and operators will be able to easily determine both how many seats or beds are occupied and exactly which seat or bed is occupied, but not necessarily monitor a change in location (as in the prior art) or the specific identify the person occupying a given space. Yet, it is within the contemplation of inventors that location and change in location may be incorporated into the present system through minor modification of the parameters and implementation of the same (or similar) existing technology, if desired.

In the novel aspects of the present invention, a “tag” is not attached to the asset (person or item), per se, as in standard Bluetooth or radio frequency tagging, but rather tags are adhered to and encapsulated within a device attached to an asset in the location to be monitored, for example a waiting room seat or a hospital or surgical center bed. Moreover, where a transport may be identifiable in relation to changes in location, which is a known application of RFID technology, the true novelty of the present invention is the determination of the presence or absence of a patient upon that transport which adds to the technological field and innovative use of ‘active’ RFID tracking technology.

Inventors introduce an augmented “line of view” concept, wherein other traditional applications of RFID tags have sought to obviate this use to require electromagnetic wave disbursement without dependance upon “line of sight”. In this application of the present technology, rather than detecting the location (and change in location) of a “tag”, through a “tracking” system, electromagnetic emissions are monitored, largely binomially, to determine whether or not they exist. With the present apparatus, system and device a BLE tag is intentionally shielded from a receivers “reading” emitted signals (through obstruction by a patient's body) whereby tags are placed at specific locations to determine the presence or absence of targeted items (patients), conformations of entrances and egresses, transport occupancy (and potentially location), hospital bed occupancy (and location) or patient presence or absence.

Yet, this “line of view” analogy is an oversimplification of the mechanism used in the present system, where it is therefore essential to notice that the BLE signal has the ability to be “seen” even if the tag is not in direct view of the receiver (unless the specifically designed and designated tag is mounted on an “opaque” (blocking) receptacle that limit the signal detection in a specific direction and range) and that non-direct detections are within the contemplation of inventors. Via this non-direct BLE signal reading, the location of a certain asset (chair or bed) may be detectable even if tagged items are relocated and subsequent tracking of a signal or signals serve to determine occupancy even out of a directly observable area. As well, it is the contemplation of inventors to use ‘peer-to-peer’ tiles, trackers or fobs, those capable of transmitting, receiving and retransmitting a signal in order to create a ‘mesh’ network of transmitters and receivers.

In its most basic permutation, the present invention consists of a wirelessly attached “tag” inside an “opaque” receptacle where only a single side of the seat allows for signal transmission whereby a tag can be “seen” by a receiver placed in the room if and only if the seat is unoccupied. Typically, a BLE tag would be placed in an inferior receptacle or portion of a seat, shielded on sides and bottom, leaving the superior area unobstructed. Once an occluding body resides over this previously open area, emitted electromagnetic signals are blocked and no signal is then detected. It may then be determined that the absence of a signal equates to the presence of a person.

A simple embodiment is to determine the number of seats occupied (conversely vacant) in the waiting room of a clinic to assess the occupancy of a waiting area. Knowing the capacity of a waiting room, or the ratio of occupied versus unoccupied seats, the percentage of occupancy (and vacancy) may then be determined. Further, knowing this ratio, set over time, will allow operators or users of the system (and accompanying data) to determine workflow and throughput, peak operation time segments, trough work flow time segments as well as movement of patients across determinable time periods, passively and agnostically, the presence or absence of patients, their movements, locations and overall space usage, among other determinable and monitorable features.

Another application would be to ensure that social distancing is satisfactory by making sure an empty seat lies between two occupied seats in a waiting room.

Yet another example is to monitor if a stretcher or hospital bed is occupied by a patient. In that case a BLE tag may be mounted below the mattress and on an “opaque” support to the BLE device which blocks a signal transmitting downwardly (removing the occurrence of reflection and untoward “rogue” transmissions) making sure that the signal can be captured or read only upwardly through the mattress.

In both examples, one takes advantage of the fact that the human body is 80% water and blocks the wireless signal of the tag if the seat or bed is occupied.

So, if a seat or bed is occupied the signal is blocked in all direction by the “opaque” support on one side and the human body on the other side.

It is important to notice that the present system needs very few BLE receivers to cover a waiting room, or hospital floor unit in order to ensure adequate coverage. Typically, one receiver mounted under the ceiling for a 20 square meter waiting room would be sufficient to capture the necessary data. In fact, inventors have successfully utilized no more than 3 receivers in an open preparation area or open recovery area hosting 10 beds each in a hospital setting.

In addition, there are a number of examples where the present invention, system and method can be used: to detect if a drawer is open or closed for safety reasons, to check if a rack of (expensive) instruments such as flexible endoscopes is full, to detect when a door stays open (or assure that a door is in a closed position).

While inventors concentrate on “active BLE” technology, inventors have a corresponding solution for “passive RFID” where, while having similar utility, the passive nature of a truly “passive RFID” tag limits the signal strength that is emitted whereas the present invention may check the presence or absence of items only close by the RFID antenna. Additionally, inventors envision a combination “active RFID” and “passive RFID” system wherein both RFID formats may be used contemporaneously or in an alternating fashion, based on desired effect, where utilization of both “active RFID” and “passive RFID” may offer a versatility and more efficient operation, in terms of utility and battery life, than the use of either alone.

### DESCRIPTION OF THE RELATED ART

Presence of people or items at a specific location might be checked by a human observant, but this is pedantic, cost inefficient and can carries innate human error.

Typically, seat or bed occupancy has been resolved by using pressure sensors that require impact by the weight of the occupant where if the seat or bed is occupied the pressure measurement is high, if not occupied then the pressure measurement is low.

Disadvantages include the requirements of pressure sensors to (1) necessarily accommodate a fairly large interval of pressure range without breaking, fatigue or false negative and (2) the need for pressure sensors and emitters to be powered by a power source requiring frequent maintenance and inspection. Moreover, cleaning/disinfecting the bed of the patient is more difficult with pressure sensors thus obfuscating the cleaning process.

Drawer or door openings and rack occupancy (e.g., flexible endoscopes in the GI context of a storage cabinet) are often detected by physical mechanical switches and connectors that might be fragile and require careful install. Moreover, being mechanical in nature, wear is inherent and inevitable over time. Similarly, these mechanical switches need to be wired or connected to a wireless emitter, of which the present device is intrinsically capable of, where omission of the mechanical features obviates repair and replacement while maintaining wireless transmission capabilities without intervening mechanical components—making for a more efficient, cost effective and ergonomic solution.

Computer vision techniques using a video camera to check occupancy may also offer a generalized solution. Pointedly, thanks to Artificial Intelligence (AI) methods such as deep learning, an algorithm can be successfully employed to check the presence or absence of specific items or people in the video feed. The system install is similar to any currently used video surveillance installation, requiring visual monitoring, intrinsic line of sight observation and a power supply. Video surveillance though may not be acceptable to a vast majority of healthcare facilities due to a potential intrusion into privacy of patients and potential prohibitions under federal HIIPA regulations. This is an especially acute area of sensitivity in the healthcare setting, which is one of the main targets for the present invention. Furthermore, wireless cameras require a sufficient power source far beyond the needs of the tag that can operate with a battery for months or years via a button cell/watch/coin cell battery.

While current technology is capable of tracking assets, including patients, with existing RTLS systems, this requires a tag attached to every subject or item: a cumbersome solution to locate unidentified people or items at specific location. It does however work best for patients or items where monitored items (and their occupancy) are primarily stationary and their status is binomial. The present “blind” monitoring system of largely stationary assets therefore circumvent individualized tracking and monitoring, protecting the identity of specific patients and requiring no registration or tag allocation, but nonetheless allowing for occupancy in a given space over time.

Optical techniques based on the obstruction of a light beam if an object or person is standing at a specific location is a possible alternative solution. This is based on the same “line of sight” concept but with a focused (i.e., directed) light beam. However, this technology requires a very careful install and calibration. Every single presence target requires a precisely positioned optical tracker without obstruction to the light sensor, so this solution is not viable in the waiting area, in hospital beds, on hospital transports or with opening and closing of doors or drawers.

The concept of detecting the presence or absence of a person on an object using wireless signals is within the prior art with RTLS technology in terms of tracking mobile retail items through “passive RFID” shadowing (See patent U.S. Pat. No. 7,081,818 “Article Identification and Tracking Using Electronic Shadows Created by RFID Tags”) and determining the “level of liquid in a container (soap) or height of a stack of items (paper towels)” through the use of “passive RFID” (See WO2012102608A1 “RFID SENSOR SYSTEM”). What is more RFID technology has been utilized to determine the use of “traffic lanes” of a parking facility (See US20120086558 “LANE POSITION DETECTION ARRANGEMENT USING RADIO FREQUENCY IDENTIFICATION”), parking space utilization (See U.S. Pat. No. 8,754,783 “ESTIMATING PARKING SPACE OCCUPANCY USING RADIOFREQUENCY IDENTIFICATION” and U.S. Pat. No. 7,768,401 “PLACE-STATUS MANAGEMENT SYSTEM, RADIO TAG READER, AND MANAGING APPARATUS”) and placement of items on a shelf (See U.S. Pat. No. 7,271,724 “INTERFERING SMART SHELF”).

The principle in all these patents about RFID technology, no matter the application, i.e parking garage inventory or shelf inventory, are based on the fact that the object is shadowing the signal. However, in the situation of interest such as an occupied bed stretcher or an occupied seat for example, we determined experimentally that the BLE signal may be shadowed by the human body, but still be seen with about the same strength by a receiver thanks to multiple reflexion of the signal on the surface of various object and walls that acts as a “mirror”. For example, using BLE technology will not work efficiently or properly because of the multiple angles of reflection of the signal on the car body (unless there is a single receiver for each tag). In the case of automobile seat location detection, locations are only determinable extremely close to the passenger (head) on the opposite site of the body part (bottom) covering the tag. (See Patent EP2254099A1 “SYSTEM FOR DETECTING PERSONS INSIDE A PASSENGER COMPARTMENT OF A VEHICLE, IN PARTICULAR AN AUTOMOBILE”). Therefore, current systems prove inadequate to address the multivariant issues encountered by inventors.

Currently, there are no inventions incorporating recognition and contemplation of the multitude of highly mutable parameters even approximating the advantages of present invention specifically for detection and monitoring of the presence or absence of a signal occluding body. Further, the present invention is capable of remediating the shortcoming of current detection and monitoring systems in terms of an automated, robust, wirelessly enabled, low-maintenance system which is non-invasive and easily installed (or retrofitted) evidencing a truly identity-blind system and method of gathering vital location and movement data as well as conformational data (i.e., open or closed) within a facility. Additionally, the present invention has the ability to operate in numerous surgical spaces, regardless of configuration or procedure type, to effectuate a more efficient and timely information detection, monitoring, recording, analysis and data recovery system.

While strides have been made to overcome the inadequacies of detecting and tracking location, movement and conformation information and data, it remains evident that considerable failings remain in the field. It is the goal of the present invention to remedy these shortcomings as to allow better monitoring and management of spatial location and conformational changes in “real-time” of facility spaces and to potentiate a system of improved understanding and appreciation of specific asset activities spatially within a facility. It is a stated goal by inventors to monitor (1) asset occupancy and use within a space while also (2) monitoring and confirming conformational changes of enclosed spaces (e.g., cabinets, drawers or rooms), thereby providing a quantitative measure of patient movement within a facility, in addition to a facility's limited resource utilization and allocation—all toward a goal maximizing availability of limited staff and space resulting in enhanced patient care and satisfaction. It is an additional subsequent goal of inventors to simultaneously improve both patient experience and medical staff job contentment and enjoyment through said improvements.

### INVENTION SUMMARY

Expressly, the present invention can detect the presence or absence of items or people at specific locations through the use of BLE “active RFID” tagging and electromagnetic signal monitoring.

A first application is to count the number of seats occupied in the waiting room at any given time of the clinic's operational hours to assess the workflow load in a waiting area as to assess flow through and clinic/hospital throughput, peak and trough occupancy, clinic/hospital efficiency as a direct or indirect indicator of patient satisfaction (through wait times and bottlenecking) or staffing requirements (peak times indicating a need for increased staff).

A second application is to monitor the percentage of capacity and/or occupancy over a specified time period where discrete segments of time may be sampled and compared to other sample periods, or conglomerates of time periods, and analyzed retrospectively, in real-time, retrospectively or prospectively to determine seat/bed use for assessing overutilization and underutilization efficiencies.

A third application is to use collected occupancy and utilization data to increase the efficient and ergonomic use of limited resources (e.g., hospital and clinic seats and beds), to determine and monitor proper staffing and utilization, to determine and monitor effective janitorial utilization and usage, and to determine and monitor patient wait times (directly, for facility space utilization and, indirectly, for patient satisfaction) and the like.

A fourth application is to monitor if and how a seat, stretcher or hospital bed is utilized by a patient without specifically identifying a patient thus avoiding HIPAA and HITECH issues involving specific protected patient information.

A fifth application is the monitoring of drawer openings and closures as to more efficiently determine and monitor utensil usage as to modify ergonomic placement of surgical tools and equipment in a clinic or surgical suite. Also, the same technology may be used to determine if a particular drawer remained open after a procedure.

A sixth application is the monitoring and detection of a refrigerator or refrigerated area wherein if a refrigerator door remains open for an extended period or is not completely closed, the contents requiring refrigeration (e.g., insulins, chemotherapeutic agents and certain injectables) may quickly lose efficacy or become ineffectual in a relatively short amount of time. Notably, the refrigerator may be the highest density of item cost, per square foot/meter, of any comparable area of a pharmacy (hospital, clinic, retail or otherwise).

A seventh application is the monitoring of the opening and closure of an ingress or egress door within a facility of hospital. Markedly, in terms of air quality, each opening and closing of a door to an enclosed space (i.e., a surgical suite) has a direct and measurable effect on air quality. As has been evidenced by inventors, introduction of particulates is highest when a surgical suite entrance has been opened and turbulent air is introduced into the surgical suite. This air must then be filtered as to decrease the presence of airborne particles and pathogens within the suite through HVAC systems and surfaces must be cleaned between patients. Correspondingly, potentially pathogen harboring particulates (which may be the pathogen itself) may also exit a surgical suite or operating room into the corridors of a facility. Thus the opening and closing of a door must be monitored in order to determine air quality both within and outside of a surgical suite area or patient's room.

The present invention, system and method of use is designed to be fully automated, robust, easy to install, wirelessly enabled, low-maintenance, agnostic as to identity and non-invasive.

### BRIEF DESCRIPTION OF THE DRAWINGS

While the novel features and method of use of the application are set forth above, the application itself, as well as a preferred mode of use, and advantages thereof, will best be understood by referencing to the following detailed description when read in conjunction with the accompanying drawings in view of the appended claims, wherein:

FIG. 1 shows a schematic of the present invention and system for a Wireless Presence Check System.

FIG. 2 depicts a preferred embodiment of the present invention and concave BLE tag placement.

FIG. 3 is an unoccupied transport and unoccluded BLE tag.

FIG. 4 illustrates an occupied transport and occluded BLE tag.

FIG. 5 shows an unoccupied seat with adhered BLE tag.

FIG. 6 is an occupied seat and occluded BLE tag.

FIG. 7 depicts a closed door and occluded signal.

FIG. 8 represents an open door and non-occluded signal.

And while the present invention, system and method of use are amendable to various modifications and alternative configurations, specific embodiments thereof have been shown by way of example in the drawings and are herein described in adequate detail to teach those having skill in the art how to make and practice the same. It should, however, be understood that the above description and preferred embodiments disclosed, are not intended to limit the invention to the particular embodiment disclosed, but on the contrary, the invention disclosure is intended to cover all modifications, alternatives and equivalents falling within the spirit and scope of the invention as defined within the claim's broadest reasonable interpretation consistent with the specification.

### DETAILED DESCRIPTION

And while the invention itself and method of use are amendable to various modifications and alternative configurations, specific embodiments thereof have been shown by way of example in the drawings and are herein described in adequate detail to teach those having skill in the art how to make and practice the same. It should, however, be understood that the above description and preferred embodiments disclosed, are not intended to limit the invention to the particular embodiment disclosed, but on the contrary, the invention disclosure is intended to cover all modifications, alternatives and equivalents falling within the spirit and scope of the invention as defined within the claim's broadest reasonable interpretation consistent with the specification.

The present invention is made of 4 basic parts in its most basic configuration: (1) a tag (that may be a BLE (active RFID) tag, a non-BLE (active RFID) tag, a “passive RFID” tag or a combination thereof), (2) a receiver that may be a wireless Bluetooth receiver or an RFID antenna, (3) a tag holder (receptacle) capable of screening signals in the “line of view” of a tag in such a way that the receiver can see the tag if and only if there is no occupancy (of a bed or chair) by a person or item and (4) an attachment or adherence of the tag holder to an asset within the location that is targeted for presence (or absence) detection. This information may then be collected and stored to a memory and subsequently transmitted to the cloud for further processing and analysis.

Manifestly, a device “containing” a BLE tag and restricting a wireless signal's reception by a wireless receiver is the most essential part of this invention whereby the BLE signal propagates in all directions, if left unconcluded, and inherently reflects off of multiple walls or objects nearby. This makes the RTLS localization process uncertain and detection undiscernible. Yet, by blocking the wireless signal with a device made of a material that dampens and absorbs the signal emitted by the BLE tag, at least on each side and bottom, inventors restrict the propagation of the signal on one side, multiple sides or via a directed signal with an angular cone (i.e., concave “dish”).

If an object or person blocks the signal on an open side of the “line of sight” view or opening of an angular cone, the signal disappears from the receiver registration and no signal is registered. This allow the present system to detect the presence or absence of an item or a person that is blocking signal transmittance from the targeted location. The individuals or items tracked block the wireless signal with the dense make-up of their constitution (i.e., the human body being occlusive and 80% water as well as with other items that are opaque, not transparent to wireless waves including most solid objects).

Without a screening (signal blocking/absorbing materials) device, a signal can easily propagate backward then reflect off of any surface to remain visible/detectable by the receiver.

The choice of the absorbing material can be simple: inventors 3D print an empty receptacle with the shape of choice that is filled by any number of signal absorbing materials of sufficient density. For example, water itself is an excellent absorbing material for wireless waves. Alternatively, and for safety purposes in a hospital environment, solid materials, other antibacterial liquids or gels may be used to fill the occlusive portions of a receptacle (e.g., alcohol liquid gel or other similar absorbing materials). What is more, the absorbing properties of the liquid, water, or alcohol liquid gel can be enhanced by mixing salt with the liquid wherein it has been determined that sea water absorbs wireless waves better than fresh water. (See RF Path and Absorption Loss Estimation for Underwater Wireless Sensor Networks in Different Water Environments, Umair Mujtaba Qureshi, Faisal Karim Shaikh, Zuneera Aziz, Syed M. Zafi S. Shah, Adil A. Sheikh, Emad Felemban and Saad Bin Qaisar Sensors 2016, 16, 890; doi:10.3390/s16060890)

To optimize the system (i.e., the shape and dimension of the screening device that holds the BLE tag), one can use either a simulation tool of electromagnetic wave propagation or a direct measurement in order to minimize the possibility of rogue reflecting waves. These non-productive waves add noise or interference to the presence detection system when the BLE tag's wireless signal is not completely blocked by the person or item blocking a signal to a receiver. Vice versa, the shape of a receptacle may be optimized or augmented in order to enhance signal recognition in order to make sure that the signal is “seen” and that the transmission is transmitted with sufficient strength to be perceived by the receiver when the person or item is not present.

Examples of commercially available BLE tags include (a) Wearable BLE Tag Long Range nRF52832 Beacon For Key Finder With Multi-color Case, (b) Jaalee Ibeacon 40 Meters in Open Air 28 mm*8 mm 12-month Bluetooth transmitter Cr2032 enabled device, and (c) SGW8130 BLE beacon Bluetooth 5.0 link Cr2032 enabled device, but other BLE device are equally within the contemplation of inventors.

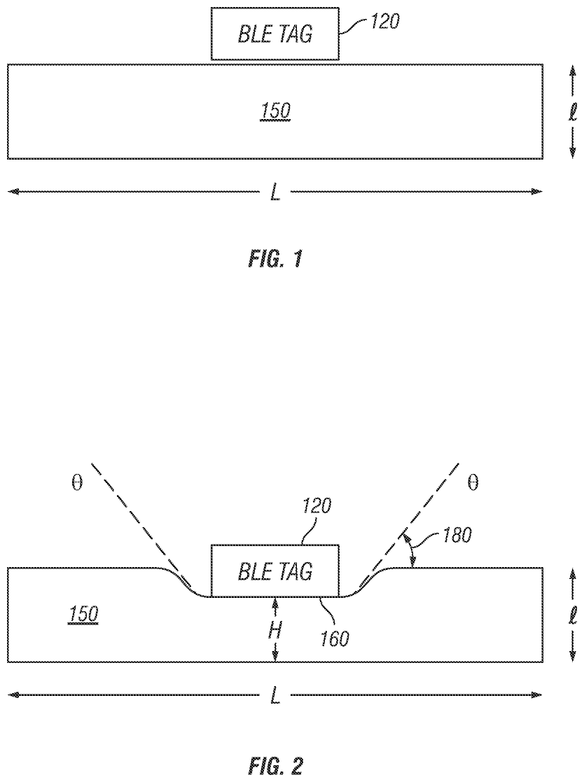

FIG. 1 is a schematic representative of the present invention which provides the basis and design premise for the present invention which is a BLE enabled detection and monitoring system 100. As can be seen, BLE tag 120 is superior to a screening area 150 having a 2-dimensional area defining the thickness of said screening area 150 whereby this the thickness is determined by L×l (‘L’ defined as length and height, depth or thickness defined as ‘l’). Area 150, being made of an absorbing material (e.g., water, liquid alcohol, salt water, etc. without limitation) where the higher the capacity or absorption of a material is inversely related to ‘l’ and as the capacity increases ‘l’ proportionally decreases.

FIG. 2 illustrates a concave depression 160 wherein BLE tag 120 is placed in a depressed area, concave indention 160, of screening are 150 limiting the “sight of view” of the BLE tag 120 to a geometric cone of angle Theta 180 in interval (0,Pi). There is a balance between sensitivity and robustness for the presence system associated to the choice of theta where Theta=0 provides the best robustness of the present invention but low sensitivity. FIG. 2 further represents the occlusion or “blocking” of a signal inferior and to either side of BLE tag 120. It is to be understood that the concave indention (here displayed 2 dimensionally) would more accurately be see as an “dish” or “bowl” where BLE tag 120 is made to rest within (or is embedded in) concave indention 160 and have the signal occluded inferiorly and about all sides of said BLE tag 120 (leaving only the superior portion of BLE tag 120 “open” and capable of emitting receivable transmission of signals.

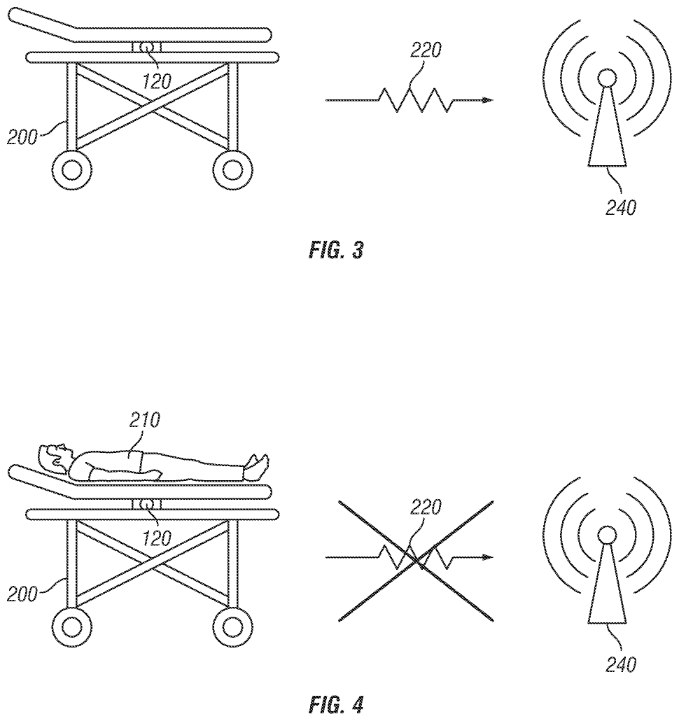

In terms of beds and transports, FIGS. 3 and 4 depict the present invention in terms of a transport 200, in the form of a bed or gurney, which may be mobile or stationary, and which denotes the present invention's vacancy (FIG. 3) and occupancy by a signal 220 occluding patient's body 210 (FIG. 4), wherein the unoccupied (vacant) bed has signal 220 freely transmitted to a receiver 240 in FIG. 3 and wherein signal 220 is “blocked” or occluded from receiver 240 in FIG. 4.

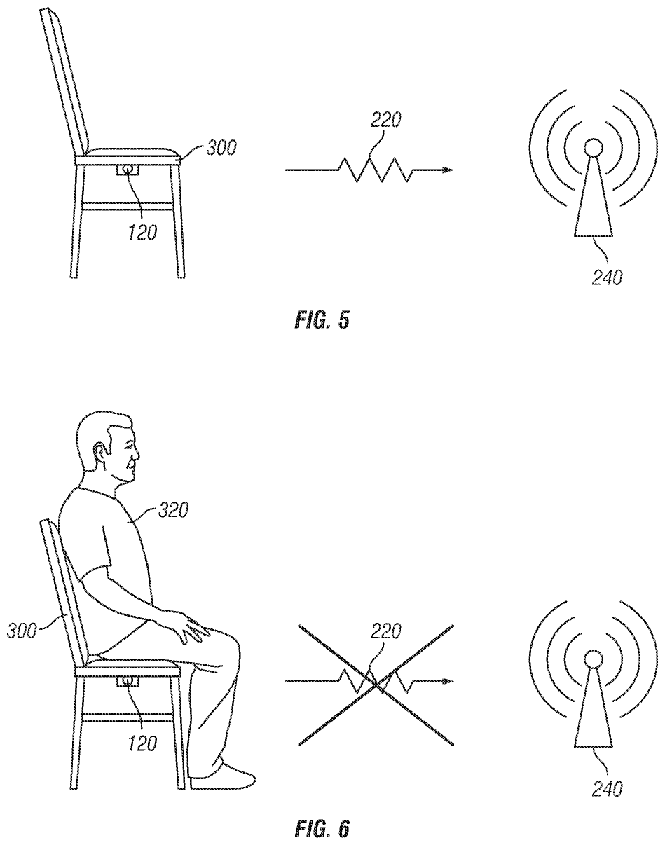

The same theory is applicable to seating, wherein in FIG. 5, seat 300 is vacant (transmitting signal 220 to receiver 240) to provide vacancy data and, in FIG. 6 occupant 320 is “blocking” or occluding wireless signal 220 from receiver 240 causing no signal to be detected and occupancy of the seat 300 to be detected, verified, monitored, tracked and recorded.

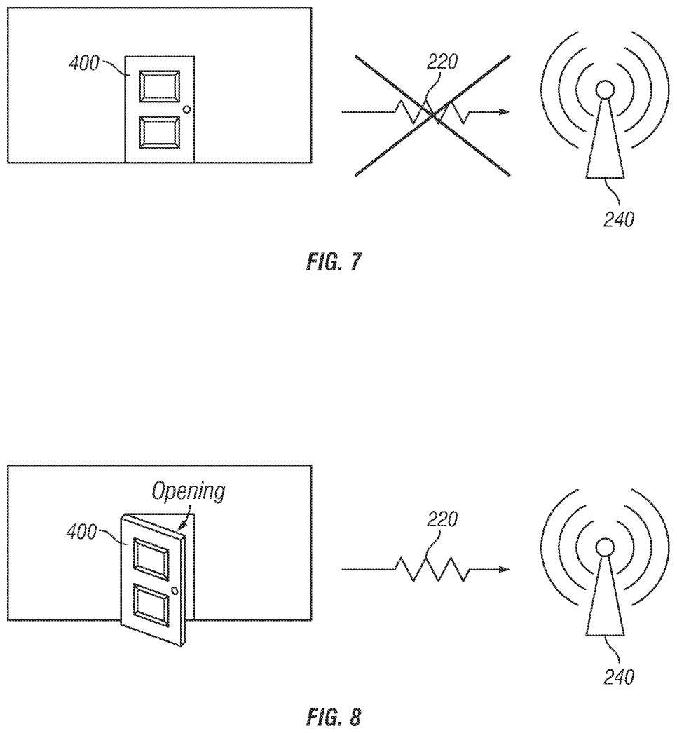

In terms of enclosed spaces (e.g., rooms), the present invention and method of operation is easily transferable to enclosures including rooms with doors, drawers, cabinets, racks, refrigerators and the like. As in FIG. 7, when a door is closed, the BLE tag is attached or adhered to the rear of the door where, depending on wall properties, the signal strength of the wireless tag measured by the receiver is blocked or advertising much lower than in open space. Conversely, when the door in an open conformation, as in FIG. 8, the device attached to the back or rear of the door is in direct line of sight of the receiver, and the signal strength is high denoting that the door is open. It is, however, within the contemplation of inventors that the BLE tag 120 may be located in other sections of the door (i.e., on the front or sides of the door or, alternatively, within the door) as to provide variable locations of BLE tag 120 placement (not shown). What is more inventors have within their purview the ability to reconfigure the systems operability and door closure allows the receive to detect a signal and door opening causes signal occlusion. Further, the same principles applicable to door opening and closure are equally and directly relatable to any like enclosure system (a refrigerator door, drawer, cabinet, rack), surgical (mayo) tray, any tool capable of movement or adjustment between use and non-use (e.g., endoscopy tower), implement, cleaning device (mop and bucket) or any other device capable of movement from one conformation to, at least, another conformation.

It is to be understood that the disclosed embodiments are merely illustrative and that forms and designs of the apparatuses, systems and methods shown and described herein are to be taken as the presently best known means of accomplishing the present invention. Elements and materials may be substituted for those illustrated and herein described, parts and processes may be rearranged, and certain features of the apparatuses, systems and methods may be utilized independently, all of which would be apparent to one having skill in the art having the benefit of this present disclosure. Changes, amendments and modifications may be made in the elements described herein without departing from the spirit and scope of the invention as described in the following claims.

### REFERENCES

[1] RF Path and Absorption Loss Estimation for Underwater Wireless Sensor Networks in Different Water Environments, Umair Mujtaba Qureshi, Faisal Karim Shaikh, Zuneera Aziz, Syed M. Zafi S. Shah, Adil A. Sheikh, Emad Felemban and Saad Bin Qaisar
Sensors 2016, 16, 890; doi:10.3390/s16060890
[2] Analysis of Human Body Shadowing Effect on Wireless Sensor Networks Operating in the 2.4 GHz Band, Lukasz Januszkiewicz
Sensors 2018, 18, 3412; doi:10.3390/s18103412
[3] Kamel Boulos M N, Berry G. Real-time locating systems (RTLS) in healthcare: a condensed primer. Int J Health Geogr. 2012; 11:25. Published 2012 Jun. 28. doi:10.1186/1476-072X-11-25
[4] Bakare, Bodunrin & Enoch, Joseph. (2019). Investigating Some Simulation Techniques for Wireless Communication System. 14. 56-65. 10.9790/2834-1403015665.
[5] Experimental Evaluation of Wireless Simulation Assumptions, David Kotz, Calvin Newport, Robert S. Gray, Jason Liu, Yougu Yuan, Dartmouth College https://digitalcommons.dartmouth.edu/cgi/viewcontent.cgi?article=4073&context=facoa

We claim:

1. A system for providing for detection and monitoring of the conformation of a device comprising:
an RFID enabled tag;
a receiver;
a tag receptacle capable of occluding signals in all directions other than the “line of view” direction of a tag in such a way that the receiver can detect said tag if and only if there is no occupancy of a bed or chair by a person or item; and
an attachment or adherence of the tag receptacle to an asset within a location that is targeted for presence or absence detection;
entering, recording, storing said detection into a memory;
and/or transmitting said information to the cloud for collection or storage.

2. The system of claim 1, wherein said tag is a BLE active RFID tag, a non-BLE (active RFID) tag, a “passive RFID” tag or a combination thereof.

3. The system of claim 2, wherein, if said RFID tag is an active tag, said tag would further encompass a battery.

4. The system of claim 3, wherein said tags may communicate directly with a receiver, may communicate with each other, may recommunicate or a combination thereof.

5. The system of claim 1, wherein said receiver may be a wireless Bluetooth receiver or an RFID antenna.

6. The system of claim 1, wherein lack of receipt of a signal indicates that said bed or chair is occupied.

7. The system of claim 1, wherein said RFID enabled tag may be attached or adhered to detectable asset whereby said RFID enabled tag is embedded within a concave enclosure to shield RFID signals in all direction but the desired direction.

8. The system of claim 1, wherein said RFID enabled tag may occlude a signal when attached to a door when the door is closed and may allow a signal when the door is open.

9. The system of claim 1, wherein said RFID enabled tag may occlude a signal when attached to an enclosure when the enclosure is closed and may allow a signal when the enclosure is open.

10. The system of claim 9, wherein said enclosure is a drawer, cabinet, rack or refrigerator door.

11. The system of claim 1, wherein said asset is any piece of facility equipment or tool capable of more than one conformation.

12. The system of claim 11, wherein said asset may be a surgical implement, scope, x-ray equipment, mayo tray or any other similar pieces of surgical or janitorial equipment.

13. A method of detection and monitoring of the conformation of the device of claim 1 by the following steps:
a. placing a BLE tag in or on an asset;
b. inserting said BLE tag within a receptacle occluding a signal from all side, except the side to be detected by a receiver;
c. transmitting a signal, in the unoccluded direction, to said receiver;
d. receiving, at the receiver, a signal;
e. determining, at the receiver, data including the absence of an occluding body at the asset, through signal receipt, or, alternatively, the presence of an occluding body, through non-receipt of a signal;
f. storing said data to a memory;
g. transmitting said data to the cloud for collection and analysis.

14. The method of claim 13, wherein said data may be receipt of a signal from a bed or chair where said bed or chair is vacant.

15. The method of claim 13, wherein said data may be no signal receipt from a bed or chair where a bed or chair is occupied.

16. A method of detection and monitoring of the conformation of the device of claim 1 by the following steps:
a. placing a BLE tag in or on an asset;
b. adhering said BLE tag on an asset, interiorly or exteriorly, or in an asset for the transmittance of a signal;
c. said asset occluding a signal when in a closed conformation;
d. said asset allowing a signal in an open conformation;
e. detecting no signal, at a receiver, when an asset is closed;
f. detecting a signal when an asset is open;
g. monitoring said closed and open status of an asset;
h. collecting data on an asset's conformation;
i. storing data on an assets conformation;
j. transmitting data on an assets conformation; and
k. analyzing data on an assets conformation.

17. The method of claim 16, wherein said asset is a room entrance or egress, a refrigerator door, a drawer or drawers, a cabinet or cabinets or any other type of openable and closable enclosure.
